(19) United States
(12) Patent Application Publication
(10) Pub. No.: US 2019/0293112 A1
(43) Pub. Date: Sep. 26, 2019

(54) UNIVERSAL JOINT SOCKET

(71) Applicant: Jhih-Sheng TSAI, Taichung City (TW)

(72) Inventor: Jhih-Sheng TSAI, Taichung City (TW)

(21) Appl. No.: 15/935,502

(22) Filed: Mar. 26, 2018

(51) Int. Cl. F16C 11/06; F16C 11/12

(52) U.S. Cl. CPC F16C 11/0623; F16C 11/12

(57) ABSTRACT

A universal joint socket has a socket unit, a joint unit, multiple balls, and a collar. The socket unit has a cavity, multiple grooves and multiple ball holes. The joint unit has a spherical joint, and a pin inserted in the spherical joint. The spherical joint is placed inside the cavity of the socket unit with an elastic element inside for supporting the spherical joint, and two ends of the pin are located respectively on the grooves of the socket unit. The balls are respectively disposed in the ball holes of the socket unit for positioning the spherical joint. The collar is mounted around the peripheral wall of the socket unit and closes openings of the ball holes of the socket unit. The universal joint socket has a long operating life and can provide a large torque.

### BACKGROUND OF THE INVENTION

### 1. Field of the Invention

The present invention relates to a universal joint socket, and more particularly to a universal joint socket that can provide a large torque.

### 2. Description of Related Art

With reference to FIG. 9, a conventional universal joint socket for a driving device, such as an impact wrench, has a socket unit 80, a joint unit 90, and a pin 87. The socket 80 has a cavity 81 and two pivot holes 83. The joint unit 90 has a spherical joint 91, and a hole 911 formed through the spherical joint 91. The spherical joint 91 of the joint unit 90 is disposed inside the cavity 81 of the socket unit 80, and the pin 87 is inserted through the hole 911 in the spherical joint 91 and the two pivot holes 83 in the socket unit 80. Two ends of the pin 87 are riveted on the peripheral wall of the socket unit 80.

However, the conventional universal joint socket has the following shortcomings:

1. The pin 87 is the weakest and the most often broken component of the universal joint socket, because the pin 87 bears the torsion force applied from the socket unit 80 and the joint unit 90.

2. The hole 911 in the spherical joint 91 has two symmetrical sectional areas. The contact between the pin 87 and a wall of the hole 911 is a line contact, and this will cause a stress concentration such that the pin 87 may be broken easily.

3. The peripheral wall of the socket unit 80 may be cracked from the pivot holes 83 in the socket unit 80 after use.

4. The pin 87 may be loosened during a high speed operation and may be spun away by inertia and injure the user, if the universal joint socket is not assembled well.

5. The connection of the universal joint socket may cause vibrations due to a large connection angle between the socket unit 80 and the joint unit 90 and a high speed operation. After long term of use, users may have occupational hand injuries.

To overcome the shortcomings, the present invention is to provide a universal joint socket to mitigate or obviate the aforementioned problems.

### SUMMARY OF THE INVENTION

The main objective of the present invention is to provide a universal joint socket which can solve the problems that the socket unit and the pin are prone to damage, and can reduce the risk of the user's occupational hand injuries after long term of use.

Another main objective of the present invention is to provide a universal joint socket which can deliver stronger torque, and the connection between the socket unit and the joint unit can reduce vibrations and enlarge the maximum connection angle between the socket unit and the joint unit.

The universal joint socket of the present invention has a socket unit, a joint unit, a pin, an elastic element, two balls and a collar.

The socket unit has a first end, a second end, an insertion cavity, multiple grooves, and multiple ball holes. The insertion cavity is formed in the socket unit and has an opening in the second end of the socket unit. The multiple grooves are respectively formed in the socket unit, and two of the grooves are diametrically opposite each other, and each groove extends in a lengthwise direction of the socket unit and communicates with the insertion cavity. The ball holes are defined through the peripheral wall of the socket unit and located near the second end of the socket unit.

The joint unit has a spherical joint disposed in the insertion cavity of the socket unit, formed on one of two ends of the joint unit, and has a pivot hole defined through the spherical joint.

The pin is inserted into the pivot hole of the joint unit in a clearance fit and a length of the pin is larger than a diameter of the spherical joint of the joint unit, and two ends of the pin are located respectively in the two grooves of the socket unit which are diametrically opposite each other.

The elastic element is disposed inside the insertion cavity of the socket unit and presses and supports the spherical joint of the joint unit.

The balls are respectively placed in the ball holes of the socket unit and protrude into the insertion cavity of the socket unit to position the spherical joint of the joint unit.

The collar is mounted around the peripheral wall of the socket unit and closes openings of the ball holes of the socket unit.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a universal joint socket in accordance with the present invention;

FIG. 2 is an exploded perspective view of the universal joint socket in FIG. 1;

FIG. 3 is a side view in partial section of the universal joint socket in FIG. 1;

FIG. 4 is a cross-sectional top view of the universal joint socket along the line 7-7 in FIG. 3;

FIG. 5 is an exploded perspective view of a second embodiment of a universal joint socket in accordance with the present invention;

FIG. 6 is a side view in partial section of the universal joint socket in FIG. 5;

FIG. 7 is an operational side view in partial section of the universal joint socket in FIG. 5;

FIG. 8 is an exploded perspective view of a third embodiment of a universal joint socket in accordance with the present invention; and

FIG. 9 is an operational side view in partial section of a conventional universal joint socket.

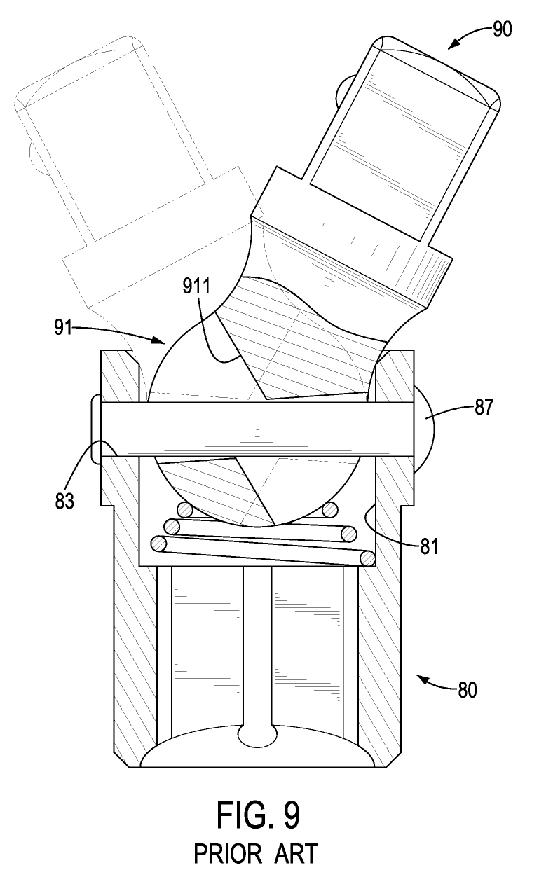

### DETAILED DESCRIPTION OF PREFERRED EMBODIMENT

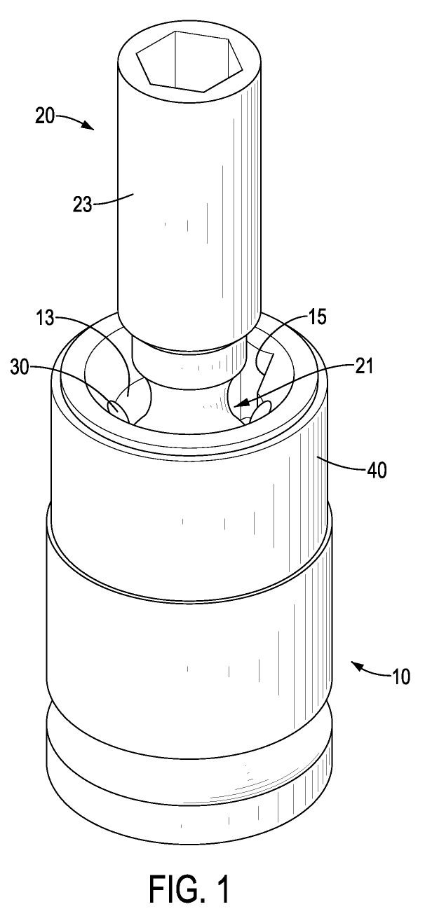

With reference to FIGS. 1 to 4, a first embodiment of a universal joint socket in accordance with the present invention comprises a socket unit 10, a joint unit 20, a pin 25, an elastic element 27, two balls 30, and a collar 40.

The socket unit 10 is a hollow cylinder, has a lengthwise direction, a first end 101, a second end 102, a junction 11, an insertion cavity 13, two grooves 15, two ball holes 17, and a collar recess 19. The junction 11 is a square cavity formed in the first end 101 of the socket unit 10 for connecting with a driving device, such as an impact wrench. The insertion cavity 13 is a circular cavity formed in the socket unit 10 and has an opening defined in the second end 102. The two grooves 15 are formed in an inner surface of the insertion cavity 13 at the second end 102 of the socket unit 10, are diametrically opposite each other, and extend from the second end 102 toward the first end 101 of the socket unit 10. Each ball hole 17 is a round through hole formed in a peripheral wall of the socket unit 10 and is located near the second end 102. The ball holes 17 and the grooves 15 are arranged in a staggered manner with respect to each other. The collar recess 19 is formed in the peripheral wall of the socket unit 10 and is recessed around the second end 102 of the socket unit 10 to define a limiting shoulder 191 on the socket unit 10.

The joint unit 20 has a spherical joint 21 and a connecting portion 23. The spherical joint 21 is formed on one end of the joint unit 20, and the connecting portion 23 is on the other end of the joint unit 20. The connecting portion 23 is adapted for connecting with a hexagon socket or serves as a hexagon socket. The spherical joint 21 has a pivot hole 211 which is a round through hole. Preferably, the pivot hole 211 is perpendicular to a lengthwise direction of the joint unit 20 and is formed diametrically through the spherical joint 21.

The pin 25 is round in cross section and is inserted in the pivot hole 211 of the joint unit 20. The length of the pin 25 is larger than the diameter of the spherical joint 21. The pin 25 and the pivot hole 211 are in a rotatable clearance fit. The spherical joint 21 of the joint unit 20 is placed inside the insertion cavity 13 of the socket unit 10, and two ends of the pin 25 are inserted respectively in the grooves 15 of the socket unit 10.

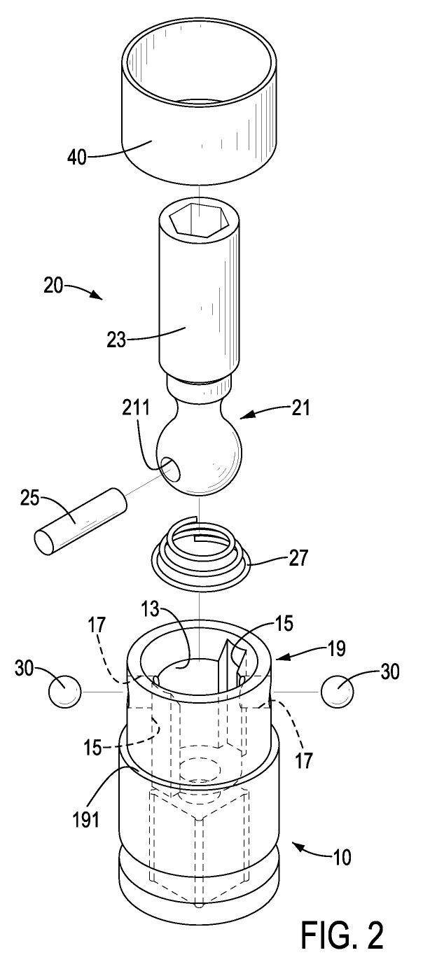

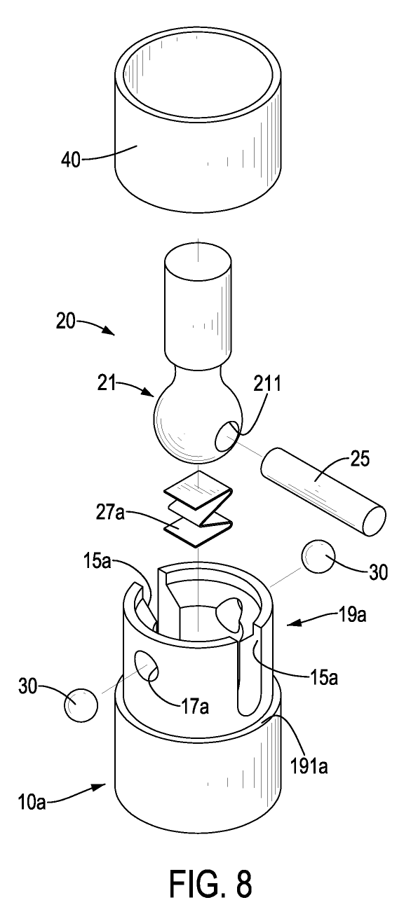

The elastic element 27, 27a may be a compression spring as shown in FIG. 2, or a sheet metal spring as shown in FIG. 8 and is placed inside the insertion cavity 13 for supporting and pressing the spherical joint 21 of the joint unit 20. The two balls 30 may be steel balls or ceramic balls. The balls 30 are placed respectively inside the ball holes 17 in the socket unit 10, and the outer diameter of each ball 30 is larger than the thickness of each ball hole 17 in the socket unit 10. The collar 40 is mounted in the collar recess 19 of the socket unit 10 and one end of the collar 40 abuts on the limiting shoulder 191. The collar 40 closes an opening of each ball hole 17 so that the two balls 30 protrude into the insertion cavity 13 and position the spherical joint 21. Preferably, the collar 40 and the collar recess 19 of the socket unit 10 are in a tight fit.

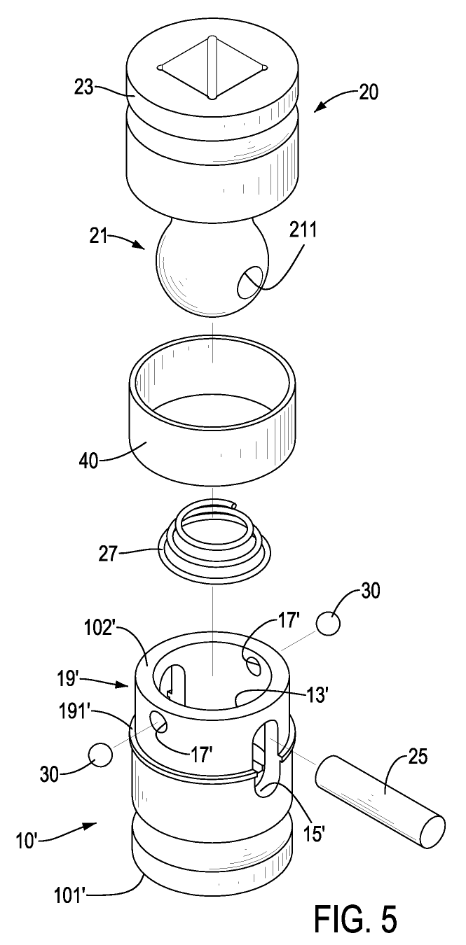

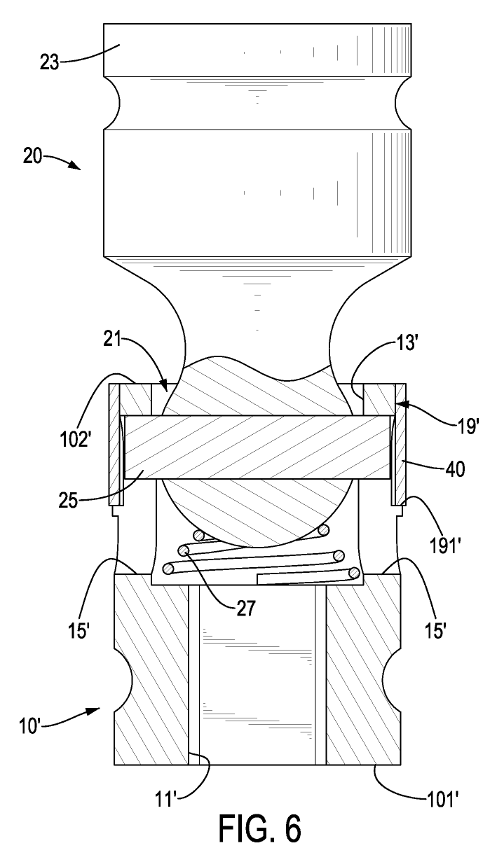

With reference to FIGS. 5 to 6, a second embodiment of a universal joint socket in accordance with the present invention is substantially same as the first embodiment except that the two grooves 15′ in the socket unit 10′ of the second embodiment are through holes formed through the peripheral wall of the socket unit 10′, are diametrically opposite each other, and communicate with the insertion cavity 13′, each groove 15′ extends longitudinally, and each groove 15′ may be a blind hole, as shown in FIG. 5. The collar recess 19′ may be a part of the peripheral wall of the socket unit 102′ near the second end 102′, and has a limiting shoulder 191′ protruding from a middle of the peripheral wall of the socket unit 10′. The collar 40 is mounted in the collar recess 19′ of the socket unit 10′ and abuts on the limiting shoulder 191′. The collar 40 closes the openings of two ball holes 17′ and closes a part of the openings of the grooves 15′, and the pin 25 is located at the closed parts of the two grooves 15′. Preferably, the collar 40 and the collar recess 19′ of the socket unit 10′ are in a tight fit.

With reference to FIG. 8, a third embodiment of a universal joint socket in accordance with the present invention is substantially same as the second embodiment except that each of the grooves 15a of the socket unit 10 is a through hole that has an opening defined in the second end 102a of the socket unit 10a, and the elastic element 27a is a sheet metal spring.

Preferred assembling steps of the first embodiment of a universal joint socket in accordance with the present invention are as follows. 1. The pin 25 is inserted into the pivot hole 211 on the joint unit 20, and the elastic element 27 is placed inside the insertion cavity 13 of the socket unit 10. 2. The two ends of the pin 25 are inserted respectively into the two grooves 15 of the socket unit 10, and the spherical joint 21 is disposed inside the insertion cavity 13 of the socket unit 10. 3. The balls 30 are respectively disposed into the ball holes 17 in the socket unit 10, and the collar 40 is then mounted from the second end 102 of the socket unit 10 toward the limiting shoulder 191 so that the collar 40 is mounted in the collar recess 19. The joint unit 20 is pushed toward the first end 101 of the socket unit 10 slightly while the collar 40 is mounted. The collar 40 will push the two balls 30 toward the insertion cavity 13 to hold the spherical joint 21 in position, and the elastic element 27 will press the spherical joint 21 toward the second end 102 of the socket unit 10 so that the spherical joint 21 and the collar 40 will mutually push the two balls 30 and the two balls 30 will not only abut and position the spherical joint 21 but also engage with the collar 40.

Preferred assembling steps of the second embodiment of a universal joint socket in accordance with the present invention are as follows. 1. The elastic element 27 is placed inside the insertion cavity 13′ of the socket unit 10′. 2. The spherical joint 21 is disposed inside the insertion cavity 13′. 3. The pin 25 is inserted from one of the grooves 15′ of the socket unit 10′ through the pivot hole 211 on the spherical joint 21 to the other groove 15′ of the socket unit 10′. 3. The balls 30 are respectively disposed into the ball holes 17′ in the socket unit 10′, and the collar 40 is then mounted from the second end 102′ of the socket unit 10′ toward the limiting shoulder 191′ so that the collar 40 is mounted in the collar recess 19. The joint unit 20 is pushed toward the first end 101 of the socket unit 10 slightly while the collar 40 is mounted. The collar 40 will push the two balls 30 toward the insertion cavity 13 to hold the spherical joint 21 in position, and the elastic element 27 will press the spherical joint 21 toward the second end 102 of the socket unit 10 so that the spherical joint 21 and the collar 40 will mutually push the two balls 30 and the two balls 30 will not only abut the spherical joint 21 but also engage with the collar 40.

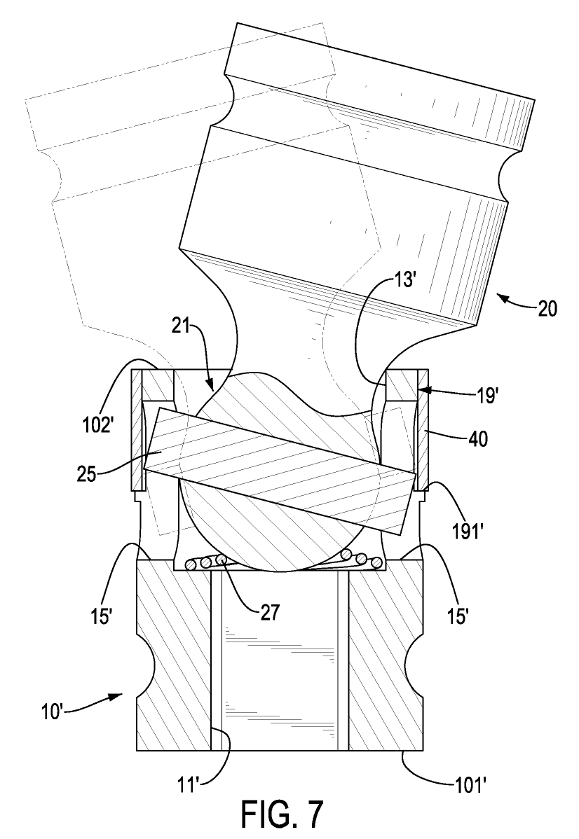

With reference to FIGS. 5 and 7, with the connection of the pin 25 and the two grooves 15′ of the socket unit 10′, the socket unit 10′ can incline and rotate relative to the joint unit 20. The elastic element 27 supports the spherical joint 21 so that the relative position of the socket unit 10′ and the joint unit 20 will not be shifted easily. When the universal joint socket of the present invention is used with a driving device, the pin 25 will bear the torsion force applied from the socket unit 10′ and the joint unit 20, and two ends of the pin 25 will push side walls of the two grooves 15′ of the socket unit 10. Because the pin 25 and the pivot hole 211 on the joint unit 20 are in a clearance fit and are assembled as one unit, the stresses on the pin 25 can be distributed to the spherical joint 21, which can enhance the strength of the pin 25, and the pin 25 can bear a strong force. Moreover, the socket unit 10′ bears the torsion force at side walls of grooves 15′ to avoid cracking on the socket unit 10′, and the useful life of the universal joint socket of the present invention could be increased.

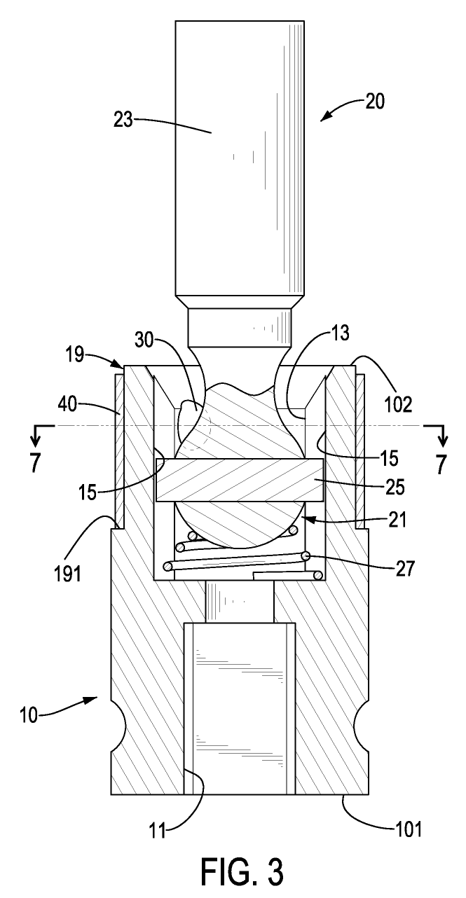

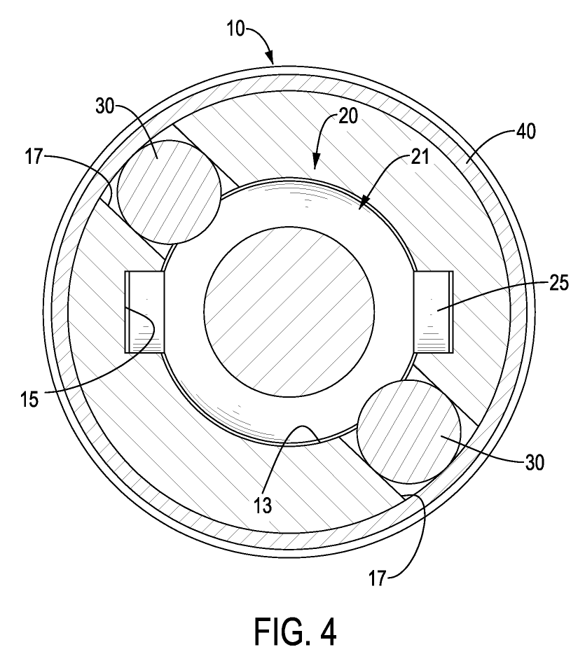

With reference to FIGS. 3 and 4, the arrangement of the two balls 30, the collar 40 and the elastic element 27 is for positioning the spherical joint 21 of the joint unit 20 inside the insertion cavity 13 of the socket unit 10. The elastic element 27 provides an outward supporting effect to the spherical joint 21, and the spherical joint 21 and the collar 40 mutually push each ball 30 so that each ball 30 not only hold the spherical joint 21 in position, but also engages with the collar 40. Moreover, using these balls 30 to position the spherical joint 21 can also enhance the smoothness of the relative rotation and enlarge the maximum connection angle between the socket unit 10 and the joint unit 20. The connection of the socket unit 10 and the joint unit 20 can also solve vibration problems due to a large connection angle between the socket unit 10 and the joint unit 20 and a high speed operation, and reduce the risk of occupational hand injuries after long term of use. In addition, components of the universal joint socket of the present invention have simple structures and can be easily assembled.

What is claimed is:

1. A universal joint socket comprising:
a socket unit having
a lengthwise direction;
a first end;
a second end;
a peripheral wall;
an insertion cavity formed in the socket unit and having an opening in the second end;
multiple grooves respectively formed in the socket unit, two of the grooves being diametrically opposite each other, and each groove extending in the lengthwise direction of the socket unit and communicating with the insertion cavity; and
multiple ball holes defined through the peripheral wall of the socket unit and located near the second end of the socket unit, each ball hole having a respective opening;
a joint unit having
two ends; and
a spherical joint disposed in the insertion cavity of the socket unit, formed on one of the ends of the joint unit, and having a diameter and a pivot hole defined through the spherical joint;
a pin inserted into the pivot hole of the joint unit in a clearance fit and having
a length being larger than the diameter of the spherical joint of the joint unit; and
two ends located respectively in the two grooves of the socket unit being diametrically opposite each other;
an elastic element disposed inside the insertion cavity of the socket unit and pressing and supporting the spherical joint of the joint unit;
multiple balls respectively mounted in the ball holes of the socket unit and protruding into the insertion cavity of the socket unit to position the spherical joint of the joint unit; and
a collar mounted around the peripheral wall of the socket unit and closing the openings of the ball holes of the socket unit.

2. The universal joint socket as claimed in claim 1, wherein the grooves are recessed longitudinally in an inner surface of the insertion cavity from the second end of the socket unit and are kept from being defined through the periphery wall of socket unit.

3. The universal joint socket as claimed in claim 1, wherein the grooves of the socket unit are defined through the periphery wall of the socket unit, and the collar closes at least a part of openings of the grooves on the socket unit, and the two ends of the pin are located at the closed part the openings of the two grooves of the socket unit.

4. The universal joint socket as claimed in claim 1, wherein the collar and the periphery wall of the socket unit are in a tight fit.

5. The universal joint socket as claimed in claim 2, wherein the collar and the periphery wall of the socket unit are in a tight fit.

6. The universal joint socket as claimed in claim 3, wherein the collar and the periphery wall of the socket unit are in a tight fit.

7. The universal joint socket as claimed in claim 4, wherein the socket unit has a limiting shoulder formed on a middle of the periphery wall, and one end of the collar abuts on the limiting shoulder of the socket unit.

8. The universal joint socket as claimed in claim 5, wherein the socket unit has a limiting shoulder formed on a middle of the periphery wall, and one end of the collar abuts on the limiting shoulder of the socket unit.

9. The universal joint socket as claimed in claim 6, wherein the socket unit has a limiting shoulder formed on a middle of the periphery wall, and one end of the collar abuts on the limiting shoulder of the socket unit.

10. The universal joint socket as claimed in claim 7, wherein the socket unit has a junction formed on the first end of the socket unit; and the joint unit has a connecting portion on the end of the joint unit opposite the spherical joint.

11. The universal joint socket as claimed in claim 8, wherein the socket unit has a junction formed on the first end of the socket unit; and the joint unit has a connecting portion on the end of the joint unit opposite the spherical joint.

12. The universal joint socket as claimed in claim 9, wherein the socket unit has a junction formed on the first end of the socket unit; and the joint unit has a connecting portion on the end of the joint unit opposite the spherical joint.

13. The universal joint socket as claimed in claim 10, wherein the elastic element is a compression spring.

14. The universal joint socket as claimed in claim 11, wherein the elastic element is a compression spring.

15. The universal joint socket as claimed in claim 12, wherein the elastic element is a compression spring.

16. The universal joint socket as claimed in claim 10, wherein the elastic element is a sheet metal spring.

17. The universal joint socket as claimed in claim 11, wherein the elastic element is a sheet metal spring.

18. The universal joint socket as claimed in claim 12, wherein the elastic element is a sheet metal spring.

19. The universal joint socket as claimed in claim 1, wherein the socket unit has a limiting shoulder formed on a middle of the periphery wall, and one end of the collar abuts on the limiting shoulder of the socket unit.

20. The universal joint socket as claimed in claim 2, wherein the socket unit has a limiting shoulder formed on a middle of the periphery wall, and one end of the collar abuts on the limiting shoulder of the socket unit.

21. The universal joint socket as claimed in claim 3, wherein the socket unit has a limiting shoulder formed on a middle of the periphery wall, and one end of the collar abuts on the limiting shoulder of the socket unit.

22. The universal joint socket as claimed in claim 3, wherein each groove of the socket unit has a respective opening defined in the second end of the socket unit.
